(19) United States
(12) Patent Application Publication
(10) Pub. No.: US 2011/0113411 A1
(43) Pub. Date: May 12, 2011

(54) PROGRAM OPTIMIZATION METHOD

(75) Inventor: Taketoshi YONEZU, Osaka (JP)

(73) Assignee: PANASONIC CORPORATION, Osaka (JP)

(21) Appl. No.: 13/009,564

(22) Filed: Jan. 19, 2011

Related U.S. Application Data
(63) Continuation of application No. PCT/JP2009/003377, filed on Jul. 17, 2009.

(30) Foreign Application Priority Data
Jul. 22, 2008 (JP) 2008-188386

(51) Int. Cl. G06F 9/45

(52) U.S. Cl. 717/153

(57) ABSTRACT

A program optimization method according to the present invention includes a processing range decision step for deciding a part of a machine language program as a processing range to which a program optimization is applied based on a description included in a high-level language program, and an allocation decision step for deciding an allocation position of an instruction code in the processing range. The description specifies a correlative relation between a plurality of processing blocks of the high-level language program. In the processing range decision step, a program part equivalent to the processing blocks confirmed as having a correlative relation therebetween by a description of the machine language program is determined as the processing range. In the allocation decision step, the allocation position of the instruction code in the processing range is determined for each of the processing blocks based on the correlative relation specified by the description.

### FIELD OF THE INVENTION

The present invention relates to a compilation method aimed at reducing a program execution time, more particularly to a program optimization method using a compiler wherein a performance deterioration caused by a cache miss is prevented from happening.

### BACKGROUND OF THE INVENTION

The entire documents of Japanese patent application No. 2008-188386 filed on Jul. 22, 2008, which include the specification, drawings, and scope of claims, are incorporated herein by reference.

A CPU processing performance is increasingly improved these days, and it is important to access a memory with less time in order to reduce a program execution time.

A well-known conventional approach to reduce the memory accessing time is to use a cache memory. A characteristic of a program is locality of reference, which is a reason why the memory accessing time can be reduced by using the cache memory.

There are two types of reference locality;
temporal locality (high possibility that the same data is re-accessed in the near future), and
spatial locality (high possibility that any data nearby is accessed in the near future).

Because of the reference locality of a program, any data stored in the cache memory is likely to be accessed in the near future. Therefore, when a memory that can be more speedily accessed than a main memory is used as the cache memory, the memory accessing time can be apparently reduced.

In the event of a cache miss in a computing system comprising a cache memory, the execution of a program takes more time. The cache memory which stores therein instruction codes is more useful when a sequence of instruction codes are executed in the order of their addresses, or when such a range of instruction codes that can be stored within the cache memory are repeatedly executed. However, a real program may adopt structural options, for example, branch, loop, and subroutine in the perspective of such factors as processing performance, efficiency of program development, restriction on memory capacity, and program readability. Therefore, it is not possible to completely control the occurrence of a cache miss when a real program is executed.

The deterioration of performance due to the cache miss was conventionally controlled by, for example, prefetching any data likely to be processed in the near future in a program currently executed in the cache memory. To improve the prefetching effect, the cache miss may be predicted by analyzing how repetitive the branch or loop is in the program. However, the branch or loop repetitiveness is usually dynamically decided during the program execution, and cannot be accurately analyzed through static analysis prior to the program execution. Thus, the data prefetch based on the static analysis of the program often results in incorrect prediction of the cache miss.

Another method for controlling the deterioration of performance due to the cache miss is to use a dynamic analysis result of the program (hereinafter, called profile information) when the program is optimized by a compiler. For example, the Patent Document 1 discloses a method wherein a primary compilation result of a program is virtually executed to calculate the profile information, followed by a second compilation based on the calculated profile information. According to the invention recited in the Cited Document 1 thus technically characterized, an object file with a prefetch instruction inserted at a suitable position therein can be extracted.

The Patent Document 2 discloses a method wherein a branch direction in a conditional branch instruction is biased based on the profile information. The Patent Document 3 discloses a method for improving cache efficiency by utilizing the spatial locality.

### PRIOR ART DOCUMENT

Patent Document 1: Unexamined Japanese Patent Applications Laid-Open No. 07-306790
Patent Document 2: Unexamined Japanese Patent Applications Laid-Open No. 11-149381
Patent Document 3: Unexamined Japanese Patent Applications Laid-Open No. 2006-309430

### SUMMARY OF THE INVENTION

### Problem to be Solved by the Invention

In these methods recited in the patent documents, however, it is necessary to extract the dynamic analysis result of the program which is the profile information. To extract the profile information, an algorithm and a compiler for profiling should be specially devised, wherein a sophisticated technical skill and an expertise analysis technique built over experiences are required.

In the conventional method which utilizes the spatial locality, source codes of a non-operable section to be processed are possibly allocated in the cache memory in the operation in a system or the execution of a plurality of tasks. In that case, the source code thus stored in the cache memory may interfere with the allocation of any necessary processes in the cache memory.

The present invention provides a program optimization method using a compiler characterized in that a performance deterioration caused by a cache miss can be inexpensively and easily controlled.

### Means for Solving the Problem

A program optimization method according to the present invention is a program optimization method executed by a compiler configured to convert a program when a high-level language program is converted into a machine language program, including:

a processing range decision step for deciding a part of the machine language program as a processing range to which the program optimization is applied based on a description included in the high-level language program; and

an allocation decision step for deicing an allocation position of an instruction code included in the processing range, wherein

the description is a description which specifies a correlative relation between a plurality of processing blocks contained in the high-level language program,

a part of the machine language program equivalent to the processing blocks between which the correlative relation is specified by the description is decided as the processing range in the processing range decision step, and

the allocation position of the instruction code included in the processing range is decided by each of the processing blocks based on the correlative relation specified by the description in the allocation decision step.

The scope of the present invention includes a compiler configured to make a computer execute the optimization method, a computer-readable recording medium in which the compiler is recorded, and an information transmission medium for transmitting the compiler via a network.

### Effect of the Invention

According to the present invention, when a program developer creates a high-level language program, he specifies a correlative relation (convergent relation) between processing blocks, and a compiler allocates instruction codes equivalent to the processing blocks between which the correlative relation is specified at suitable positions. This technical characteristic inexpensively and easily avoids the occurrence of a cache miss, thereby preventing a performance deterioration caused by the cache miss from happening.

### BRIEF DESCRIPTION OF THE DRAWINGS

FIG. 1A is a diagram of a first allocation layout illustrating the allocation of instruction codes on lines of a cache memory.

FIG. 1B is a diagram of a second allocation layout illustrating the allocation of instruction codes on lines of a cache memory.

FIG. 2A is a flow chart illustrating a processing task A to be optimized.

FIG. 2B is a flow chart illustrating a processing task B to be optimized.

FIG. 3A is a flow chart illustrating a high-level language program which is a programming example.

FIG. 3B is a flow chart illustrating a machine language program which is an example in which the high-level language program illustrated in FIG. 3A is executed by a compiler.

FIG. 4A is a diagram 1 illustrating an example in which a program optimization is executed by a compiler according to an exemplary embodiment 1 of the present invention.

FIG. 4B is a diagram 1 illustrating the example in which the program optimization is executed by the compiler according to the exemplary embodiment 1.

FIG. 5 is a diagram illustrating an overall configuration of the compiler according to the exemplary embodiment 1.

FIG. 6 is a diagram illustrating in detail a linkage unit of a compiler according to an exemplary embodiment 2 of the present invention.

FIG. 7 is an illustration of a cache memory according to the exemplary embodiment 2.

FIG. 8 illustrates a relevance between an address in a main memory address and an address in the cache memory according to the exemplary embodiment 2.

### EXEMPLARY EMBODIMENTS FOR CARRYING OUT THE INVENTION

Hereinafter, a compiler which converts program described in a high-level language (called high-level language program) into a program described in a machine language (called machine language program), and a program optimization executed by the compiler are described. In the present invention, a processing block denotes an assembly of instruction codes written by a function having a feature in a high-level language or at least an instruction code written on a cache memory. The instruction code has a technical concept different to an instruction code indicating a machine language program generated by a compiler.

The machine language program is executed by a computer comprising a cache memory. As far as the machine language program includes neither branch nor subroutine invocation and is continuously allocated in a region in an address space, the occurrence of a cache miss is less unlikely, and a performance deterioration which may be caused by the cache miss is not a huge problem. A real machine language program, however, includes branch or subroutine invocation and is dividingly allocated in different regions in the address space. When such a machine language program is executed, therefore, a performance deterioration resulting from the cache miss can be a serious issue.

In exemplary embodiments described below, the present invention is applied to a compiler configured to convert a high-level language program including a plurality of processing tasks or a plurality of operation modes into a machine language program and execute a program optimization in which allocation positions of instruction codes included in the machine language program are decided. In the exemplary embodiments described below, the present invention is applied to optimization of a high-level language program including a plurality of processing tasks or a plurality of operation modes. In the description below, C language is used as an example of the high-level language, however, the high-level language or machine language can be arbitrarily selected.

### Exemplary Embodiment 1

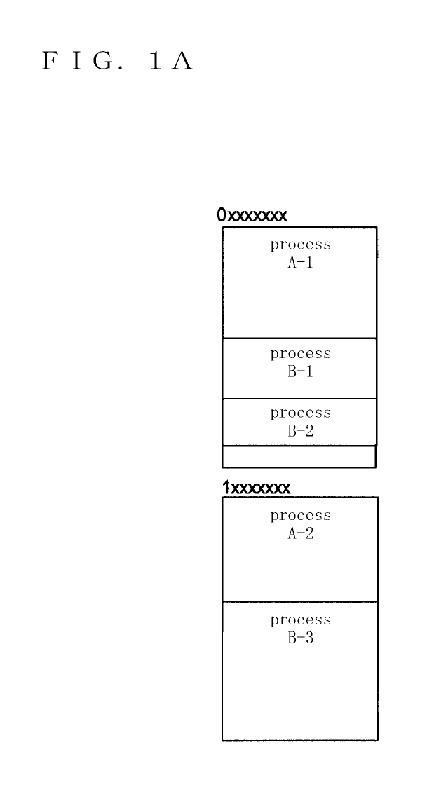

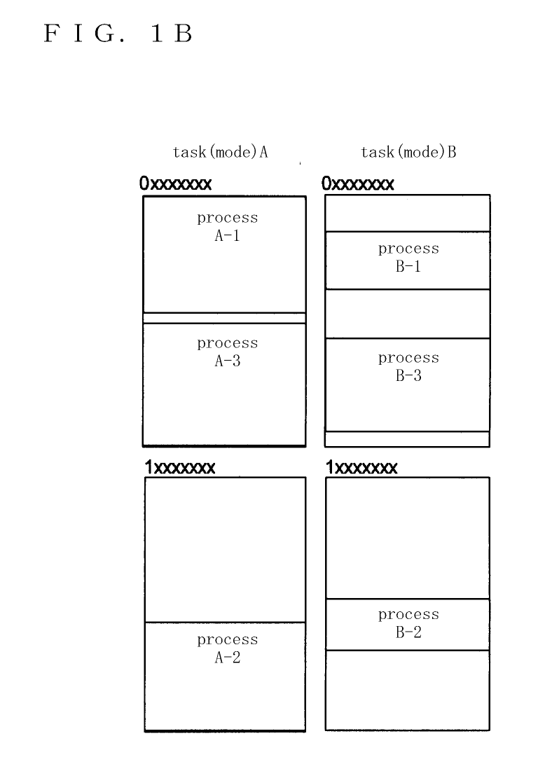

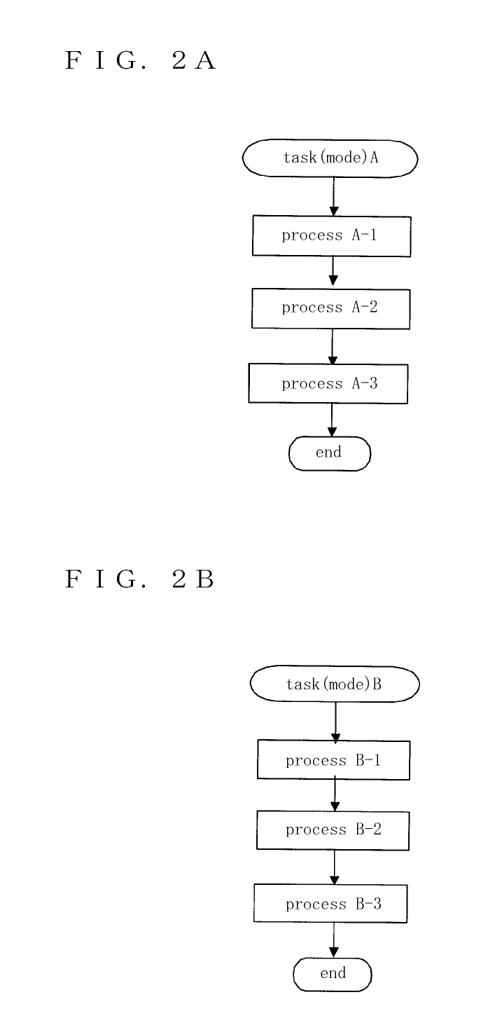

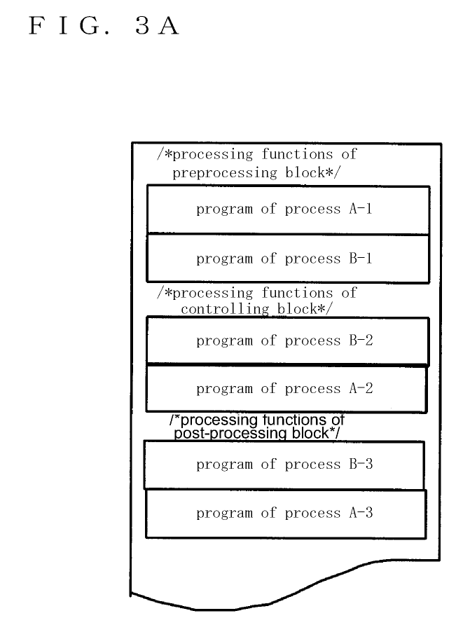

Referring to FIGS. 1A - 5 is described an example in which a program optimization is executed by a compiler according to an exemplary embodiment 1 of the present invention. FIGS. 1A and 1B illustrate the allocation of instruction codes included in a machine language program on lines of a cache memory. The instruction codes illustrated in FIGS. 1A and 1B respectively correspond to processes illustrated in a flow chart of FIG. 2. In the processes illustrated in FIG. 2, processing blocks for a plurality of processing tasks (or a plurality of operation modes) are illustrated. As illustrated in FIG. 1A, the instruction codes equivalent to these processes include instruction codes equivalent to the processing blocks.

FIGS. 1A and 1B illustrate the allocation of the instruction codes on two ways of the cache memory. The cache memory illustrated in FIG. 1A has two ways where the respective processing blocks are allocated. These processing blocks allocated on the ways are respectively processed by the different processing tasks (or operation modes). Such an allocation of the processing blocks is called a first allocation layout. The first allocation layout can be obtained by a conventional compiler.

FIG. 1B illustrates a plurality of ways where a plurality of processing blocks are allocated, however, the processing blocks allocated on the respective ways are processed by the same processing task (or the same operation mode). Such an allocation of the processing blocks is called a second allocation layout. The second allocation layout is obtained by the compiler according to the present exemplary embodiment. In the second allocation layout, the processing blocks of the plurality of processing tasks (or the plurality of processing modes) are overwritten and allocated on the ways of the cache memory.

In the description of the present exemplary embodiment, data is prefetched per line when a computer executes the machine language program. In other words, when an instruction code is read and a cache miss occurs, instruction codes for one line including the read instruction code are transferred from the main memory to the cache memory.

Below is described a cache miss generated under the set condition. When a sequential process is executed in the first allocation layout (FIG. 1A), the instruction of the processing block corresponding to a process A-1 of a processing task A (or processing mode A) is prefetched in the cache memory. However, when the instruction of the processing block corresponding to a process A-2 of the processing task A (or processing mode A) is executed, the instruction of the processing block corresponding to the process A-2 is not stored in the cache memory. Therefore, it is already very possible then that the cache miss occurs. When the cache miss occurs, the processes A-2 and A-3 are transferred from the main memory to the cache memory. In the first allocation layout, the cache miss is generated in a sequence of processes associated with the processing task A (or operation mode A) by the processing block associated with an unprocessed (uncorrelated) processing task B (or operation mode B).

In the second allocation layout (FIG. 1B), the processes A-1, A-2, and A-3 are prefetched in the cache memory when the processes associated with the processing task A (or operation mode A) are executed, and the process A-2 is stored in the cache memory when the process A-2 is executed after the process A-1. Therefore, there is no cache miss in a sequence of processes associated with the processing task A (or operation mode A). Thus, the second allocation layout can avoid the risk of cache miss.

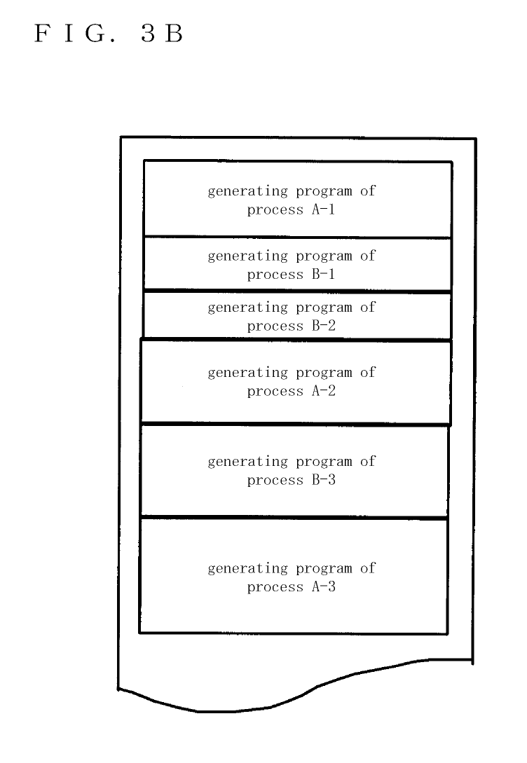

When a program developer draws up a conventional programming based on the flow charts of FIGS. 2A and 2B, a high-level language program illustrated in FIG. 3A is obtained. When the high-level language program is processed by the conventional compiler, a machine language program illustrated in FIG. 3B is obtained. In the machine language program, the processing blocks of the processing task A (or operation mode A) and the processing blocks of the processing task B (or operation mode B) are mixedly allocated. In the case where the description of processes in the high-level language program includes any part inappropriate for the machine language program when the conventional programming is drawn up, the instruction codes equivalent to the processes associated with the processing tasks A and B (more specifically, instruction codes corresponding to the processes) may be confusingly stored in the cache memory when the generated instruction codes of the machine language program (corresponding to the processes of the high-level language program) are allocated. Under such circumstances, the cache miss is more likely to occur.

According to the present exemplary embodiment, when the program developer creates a high-level language program including a plurality of processing tasks (or a plurality of operation modes), he specifies a group of processing blocks having a relation described below therebetween as a group of processing blocks (hereinafter, called a first group of processing blocks) with no correlative relation (convergent relation) therebetween. The relation is decided depending on whether the processing blocks are executed in a processing sequence. It is determined that the processing blocks which are not executed in a processing sequence are included in the first group of processing blocks. On the other hand, it is determined that the processing blocks which are executed in a processing sequence are included in a group of correlated processing blocks different to the first group of processing blocks (hereinafter, called a second group of processing blocks). The processing sequence includes the same tasks, or operation modes which are not concurrently processed.

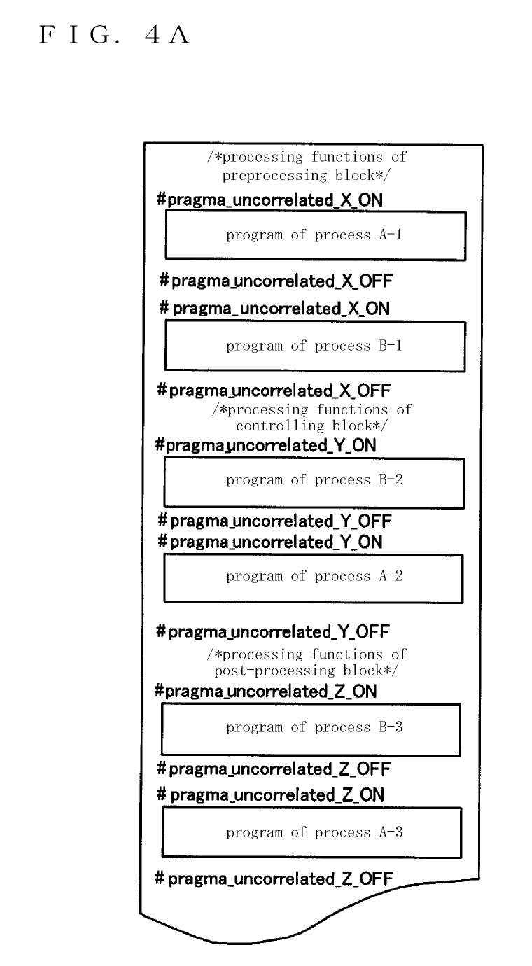

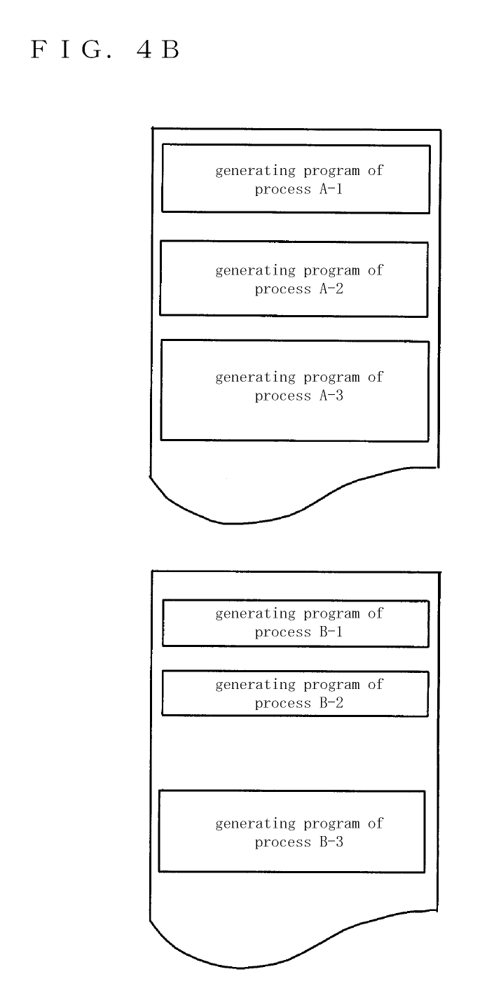

A more detailed description is given below. As illustrated in FIG. 4, the program developer specifies the first group of processing blocks using a #pragma pre-processor directive. The #pragma pre-processor directive has a function of invoking a #pragma pre-processor. It is determined that any processing blocks interposed between a #pragma pre-processor directive having a parameter_uncorrelated_ON (no-correlation setting is ON) and a #pragma pre-processor directive having a parameter _uncorrelated_OFF (no-correlation setting is OFF) are included in the first group of processing blocks. The #pragma pre-processor directives thus positionally related are equivalent to a description which designates a correlative relation (convergent relation) between the processing blocks included in the high-level language program.

When a high-level language illustrated in FIG. 4A is processed by the compiler according to the present exemplary embodiment, a machine language program illustrated in FIG. 4B is obtained. When the processes associated with the processing task A (or operation mode A) are executed in the machine language program, the instruction code subsequent to the process A-1 (process A-2 in this description) is allocated immediately after the process A-1 in the cache memory. As a result, the processes A-1-A-3 in the machine language program are allocated at positions different to positions in the description of the high-level language program. According to the present exemplary embodiment, an arbitrary instruction code included in the first group of processing blocks thus extracted is not immediately followed by any other instruction code included in the first group of processing blocks (uncorrelated). Instead, an instruction code included in the second group of processing blocks (correlated) is allocated immediately after the extracted instruction code included in the first group of processing blocks. Any other instruction codes included in the first group of processing blocks are allocated at other positions of the program. Accordingly, the instruction codes equivalent to a processing sequence associated with the processing task A (or operation mode A) are stored at the same time in the cache memory. As a result, the occurrence of a cache miss can be controlled.

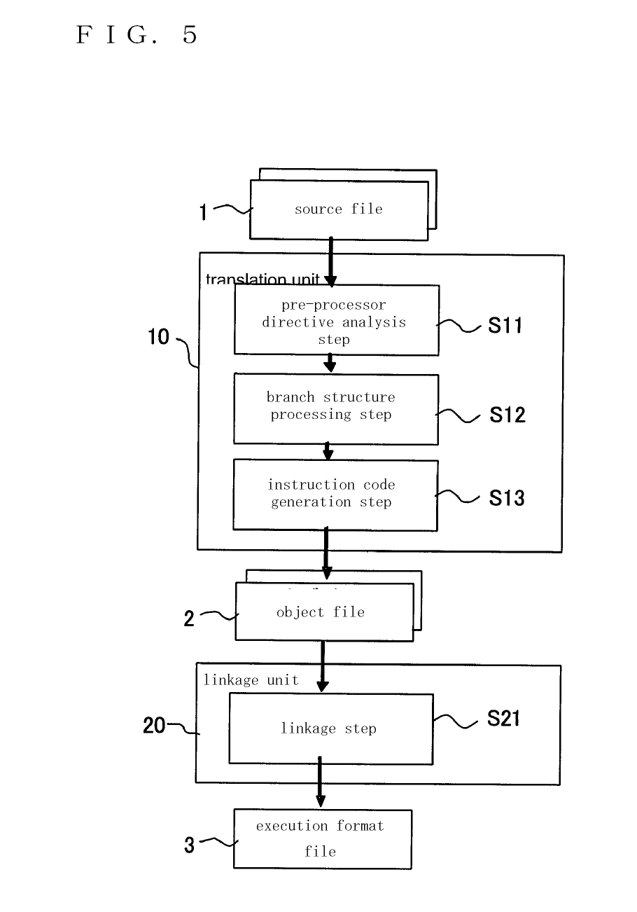

Hereinafter, a configuration of the compiler according to the present exemplary embodiment is described referring to FIG. 5. FIG. 5 illustrates an overall configuration of the compiler according to the present exemplary embodiment. As illustrated in FIG. 5, the compiler according to the present exemplary embodiment includes a translation unit 10 and a linkage unit 20. The translation unit 10 generates an object file 2 based on an inputted source file 1. The linkage unit 20 generates an execution format file 3 based on the generated object file 2. A high-level language program is recorded in the source file 1, and a machine language program is recorded in the object file 2 and the execution format file 3.

The transmission unit 10 executes a pre-processor directive analysis step S11, a branch structure processing step S12, and an instruction code generation step S13. In the pre-processor directive analysis step S11, the #pragma pre-processor directive which specifies the correlative relation (convergent relation) between the processing blocks is extracted from the high-level language program recorded in the source file. In the branch structure processing step S12, a branch instruction is generated based on the correlative relation (convergent relation) specified between the processing blocks (first group of processing groups). In the instruction code generation step S13, instruction codes other than the branch instruction generated in the branch structure processing step S12 are generated and allocated so that the correlated instruction codes (convergent relation therebetween) are continuous. The generated instruction codes are recorded in the object file as the pre-link machine language program.

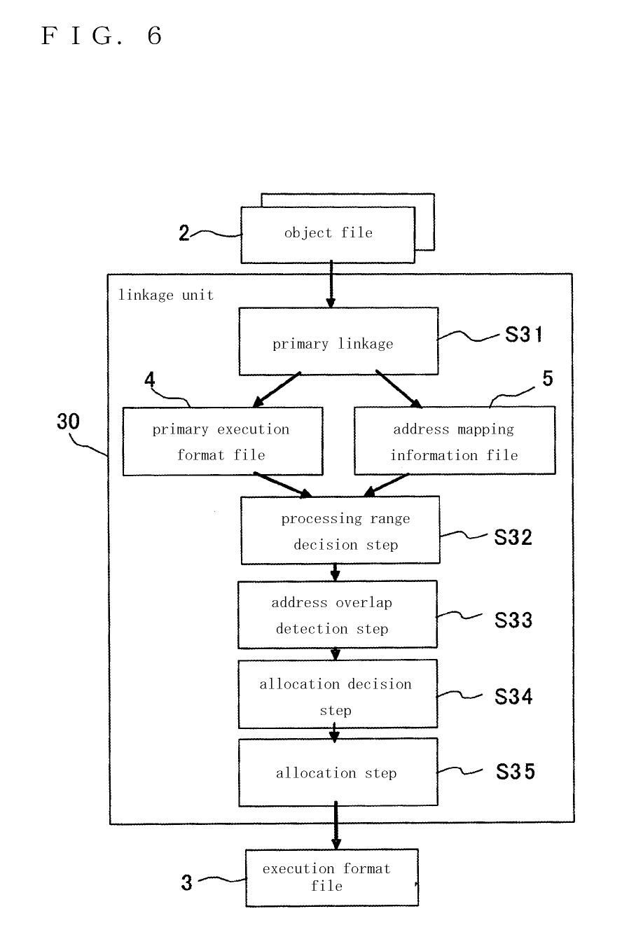

The branch structure processing step S12 and the instruction code generation step S13 respectively correspond to a processing range decision step for deciding a part of the machine language program as a processing range to which the program optimization is applied based on a description included in the high-level language program, and an allocation decision step for deicing an allocation position of an instruction code included in the processing range. Step S34 illustrated in FIG. 6 according to an exemplary embodiment 2 of the present invention, which will be described later, rearranges the instruction codes using the branch instruction (decides positions of the instruction codes to improve efficiency) so that the correlated processing blocks (processing blocks included in the second group of processing blocks) are continuously allocated.

The linkage unit 20 executes a linkage step S21. In the linkage step S21, a linkage process is applied to the pre-link machine language program recorded in the object file 2. The post-link machine language program is recorded in the execution format file 3.

As described so far, in the case where the inputted high-level language program includes the description specifying the first group of processing blocks, the compiler according to the present exemplary embodiment does not allocate an arbitrary processing block included in the first group of processing blocks immediately after another arbitrary processing block similarly included in the first group of processing blocks.

The program developer who fully understands the operation of the high-level language program knows well which processing blocks are included in the first group of processing blocks in a program he is currently developing. Therefore, the program developer can usually correctly specify the processing blocks to be included in the first group of processing blocks. When the program developer draws up the high-level language program, he specifies the first group of processing blocks. In the case where reproduction-associated processes and recording-associated processes are operated in different operation modes independent form each other, for example, the program developer, if the program he is currently developing includes processing blocks necessary for the reproduction-associated processes and processing blocks necessary for the recording-associated processes, specifies the processing blocks necessary for the reproduction-associated processes and the processing blocks necessary for the recording-associated processes as the first group of processing blocks.

The compiler according to the present exemplary embodiment allocates the branch instruction after an arbitrary processing block (instruction code) included in the first group of processing blocks, but does not allocate another arbitrary processing block (instruction code) included in the first group of processing blocks immediately after or near the branch instruction. In other words, the compiler allocates the branch instruction after an arbitrary processing block (instruction code) included in the first group of processing block, and then allocates any processing block (instruction code) included in the second group of processing blocks immediately after or near the branch instruction. Accordingly, the cache miss likely to occur when a sequence of processing blocks are executed is controlled so that a performance deterioration due to the cache miss can be prevented from happening.

### Exemplary Embodiment 2

Referring to FIGS. 6-8, an example in which a program is executed by a compiler according to an exemplary embodiment 2 of the present invention is described. A description specifying a correlative relation (convergent relation) between processing blocks included in a high-level language program is similar to the description illustrated in FIG. 4A.

The exemplary embodiment 1 allocated any instruction code (processing block) included in the second group of processing blocks immediately after an arbitrary instruction code similarly included in the first group of processing blocks in place of another arbitrary instruction code similarly included in the first group of processing blocks.

The exemplary embodiment 2 allocates the processing blocks included in the first group of processing blocks at address positions on the main memory so that they are allocated at the same address positions on the cache memory, thereby more effectively preventing the performance deterioration caused by the cache miss.

To calculate the allocation positions of the instruction codes, the compiler according to the present exemplary embodiment decides a part of the machine language program as the processing range based on the description included in the high-level language program, and decides an allocation position of the instruction code in the processing range.

Referring to FIG. 6, the compiler according to the present exemplary embodiment is described. Though an overall configuration of the compiler according to the present exemplary embodiment is similar to that of the compiler according to the exemplary embodiment 1 (see FIG. 5), the compiler according to the present exemplary embodiment includes a linkage unit 30 in place of the linkage unit 20 illustrated in FIG. 5. The linkage unit 30 executes a primary linkage step S31, a processing range decision step S32, an address overlap detection step S33, an allocation decision step S34, and an allocation step S35. The linkage unit 30 further includes a primary execution format file 4 in which output data of the primary linkage step S31 is recorded, and an address mapping information file.

In the primary linkage step S31, the link process is executed by the machine language program recorded in the object file 2, and an executable machine language program (post-link machine language program) and subroutine or label address information are thereby generated. The executable machine language program is recorded in the primary execution format file 4, and the address information is recorded in the address mapping information file 5. The primary execution format file 4 further records therein information which specifies any process determined as having a high priority in the high-level language program.

In the processing range decision step S32, the correlative relation (convergent relation) between the processing blocks is analyzed based on the data content recorded in the primary execution format file 4. As a result, the instruction codes equivalent to the processing blocks included in the first group of processing blocks which are uncorrelated (no convergent relation therebetween) are selected as a processing target.

In the address overlap detection step S33, addresses on the main memory of a plurality of instruction codes included in the first group of processing blocks are calculated based on the data content recorded in the address mapping information file 5. Further, a plurality of instruction codes with no overlap between their storage positions in the cache memory are extracted from the instruction codes equivalent to the processing blocks included in the first group of processing blocks based on the calculated addresses and information of the cache memory configuration.

In the allocation decision step S34, in the presence of the instruction codes with no overlap between their storage positions in the cache memory, the allocation positions of the instruction codes are decided so that these instruction codes are allocated in an overlapping manner. In the allocation step S35, the instruction codes equivalent to the first group of processing blocks are allocated at the positions decided in the allocation decision step S34.

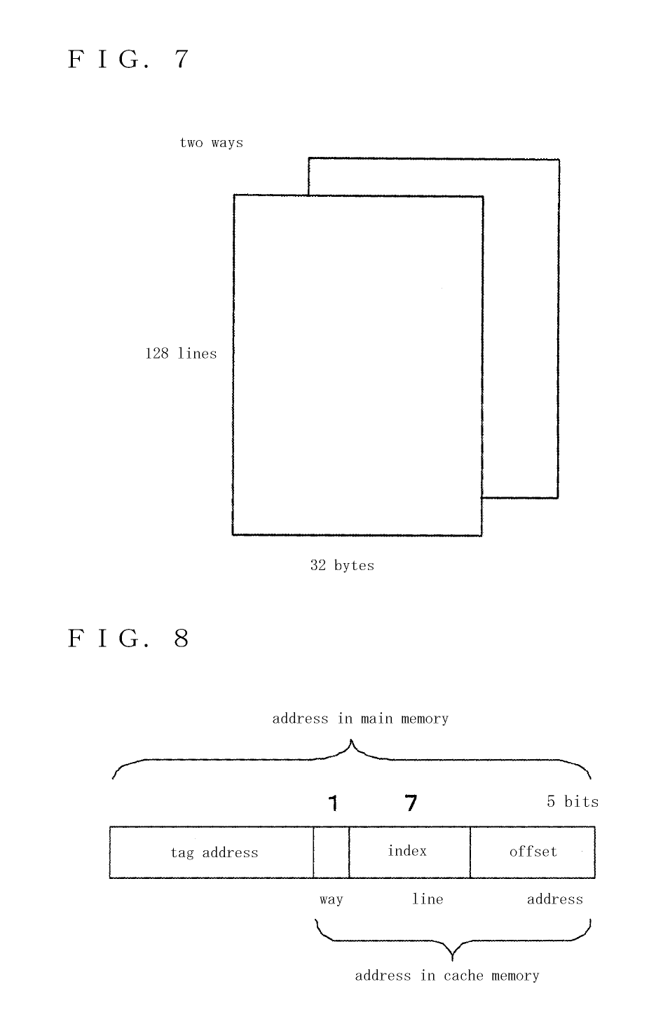

Referring to FIGS. 7 and 8 is described a relevance between an address in the main memory and an address in the cache memory (used in the address overlap detection step S33). The cache memory in the description given below is a 2-way set associative cache memory having the line size of 32 bytes and the total capacity of 8K bytes (see FIG. 7).

Assuming that the address width of the main memory is 32 bits, least significant 13 bits thereof correspond to an address in the cache memory (see FIG. 8). The address of the cache memory is divided into a least significant bit (1 bit) of a tag address, index (7 bits), and offset (5 bits). The least significant bits of the tag address specify one of the two ways, the index specifies a line, and the offset specifies a byte on the line.

In the case where 8 bits, which are the sum of the least significant bits of the tag address and the index, in the addresses of the instruction codes equivalent to two processes in the main memory are coincident with each other, these two instruction codes are overlappingly allocated in the cache memory. In the address overlap detection step S33, it can be determined whether the storage positions of the instruction codes in the cache memory are overlapping by checking whether a part of the addresses in the main memory are coincident.

The compiler according to the present exemplary embodiment allocates the instruction codes equivalent to the first group of processing blocks in the cache memory so that the addresses of their storage positions overlap with each other. As a result, the performance deterioration caused by the occurrence of a cache miss can be prevented from happening.

In the first and second exemplary embodiments, it is determined that the part interposed between the #pragma pre-processor directive in which the parameter is ON and the #pragma pre-processor directive in which the parameter is OFF in the high-level language program is included in the first group of processing blocks (uncorrelated) (no convergent relation therebetween). This corresponds to a description which specifies a first range included in the high-level language program and also a description which selects a part of the machine language program corresponding to the first range as the processing range. The method of specifying the first group of processing blocks is not limited thereto. Hereinafter, other specifying methods 1 and 2 are described.

Other Specifying Method 1

Some of diverse high-level language programs include a first description recited below. Breaking down a plurality of processing blocks constituting the first group of processing blocks into a group of processing sections more finely divided, the first description is a #pragma pre-processor directive which extracts a group of processing sections determined as correlated (convergent relation therebetween) from the first group of processing blocks and specifies the extracted group of processing sections.

Using the first description as a criterion of discrimination, a second range in the first range included in the high-level language program can be decided as the processing range. In other words, a program part equivalent to a range obtained by excluding the second range from the first range in the machine language program can be decided as the processing range.

Other Specifying Method 2

Some of diverse high-level language programs include second and third descriptions recited below. The second description is a #pragma pre-processor directive which specifies the second group of processing sections (correlated (convergent relation therebetween)). Breaking down a plurality of processing blocks constituting the second group of processing blocks into a group of processing sections more finely divided, the third description is a #pragma pre-processor directive which extracts a group of processing sections determined as uncorrelated (no convergent relation therebetween) from the second group of processing blocks and specifies the extracted group of processing sections.

Using the second and third descriptions as a criterion of discrimination of the processing range, a program part equivalent to a range of the machine language program other than the first range, or the second range included in the first range of the high-level language program can be specified.

Using the second and third descriptions as a criterion of discrimination of the processing range, a part of the machine language program except for the first range from which the second range is excluded can be decided as the processing range.

The compiler according to the present invention described so far is a compiler configured to make a computer execute the optimization methods according to the first and second exemplary embodiments. The recording medium according to the present invention is a computer-readable recording medium in which the compiler configured to make the computer execute the optimization methods according to the first and second exemplary embodiments is recorded. The information transmission medium according to the present invention is an information transmission medium for transmitting the compiler configured to make the computer execute the optimization methods according to the first and second exemplary embodiments via, for example, the Internet.

### INDUSTRIAL APPLICABILITY

The optimization method accomplished by the compiler according to the present invention can easily and inexpensively prevent a performance deterioration caused by the occurrence of a cache miss. The optimization method thus technically advantageous can be used in a variety of compilers which convert a high-level language program into a machine language program.

### DESCRIPTION OF REFERENCE SYMBOLS

1 source file
2 object file
3 execution format file
4 primary execution format file
5 address mapping information file
10 translation unit
20, 30 linkage unit
S11 pre-processor directive analysis step
S12 branch structure processing step
S13 instruction code generation step
S21 linkage step
S31 primary linkage step
S32 processing range decision step
S33 address overlap detection step
S34 allocation decision step
S35 allocation step

What is claimed is:

1. A program optimization method executed by a compiler configured to convert a program when a high-level language program is converted into a machine language program, including:
a processing range decision step for deciding an arbitrary part of the machine language program as a processing range to which the program optimization is applied based on a description included in the high-level language program; and
an allocation decision step for deicing an allocation position of an instruction code included in the processing range, wherein
the description is a description which specifies a correlative relation between a plurality of processing blocks contained in the high-level language program,
a part of the machine language program equivalent to the processing blocks between which the correlative relation is specified by the description is decided as the processing range in the processing range decision step, and
the allocation position of the instruction code included in the processing range is decided by each of the processing blocks based on the correlative relation specified by the description in the allocation decision step.

2. The program optimization method as claimed in claim 1, wherein
the allocation positions of the instruction codes included in the processing range are decided in the allocation decision step so that a description order in the description is different to an allocation order of the instruction codes in the machine language program.

3. The program optimization method as claimed in claim 1, wherein
the description further includes a description section which specifies a first range included in the high-level language program, and
a part of the machine language program corresponding to the first range is decided as the processing range in the processing range decision step.

4. The program optimization method as claimed in claim 3, wherein
the description further includes a description section which specifies a second range included in the first range, and
a part of the machine language program corresponding to a range obtained by excluding the second range from the first range is decided as the processing range in the processing range decision step.

5. The program optimization method as claimed in claim 1, wherein
the description further includes a description section which specifies a first range included in the high-level language program, and
a part of the machine language program corresponding to a range other than the first range is decided as the processing range in the processing range decision step.

6. The program optimization method as claimed in claim 1, wherein
the description further includes a description section which specifies a second range included in the first range, and
a part of the machine language program corresponding to a range except for the first range from which the second range is excluded is decided as the processing range in the processing range decision step.

7. A compiler configured to make a computer convert a high-level language program into a machine language program and optimize a program, wherein
the program optimization includes:
a processing range decision step for deciding a part of the machine language program as a processing range to which the program optimization is applied based on a description included in the high-level language program; and
an allocation decision step for deicing an allocation position of an instruction code included in the processing range, wherein
the description is a description which specifies a correlative relation between a plurality of processing blocks contained in the high-level language program,
a part of the machine language program equivalent to the processing blocks between which the correlative relation is specified by the description is decided as the processing range in the processing range decision step, and
the allocation position of the instruction code included in the processing range is decided by each of the processing blocks based on the correlative relation specified by the description in the allocation decision step.

8. A computer-readable recording medium in which a compiler configured to make a computer convert a high-level language program into a machine language program and optimize a program is recorded, wherein
the program optimization includes:
a processing range decision step for deciding a part of the machine language program as a processing range to which the program optimization is applied based on a description included in the high-level language program; and
an allocation decision step for deicing an allocation position of an instruction code included in the processing range, wherein
the description is a description which specifies a correlative relation between a plurality of processing blocks contained in the high-level language program,
a part of the machine language program equivalent to the processing blocks between which the correlative relation is specified by the description is decided as the processing range in the processing range decision step, and
the allocation position of the instruction code included in the processing range is decided by each of the processing blocks based on the correlative relation specified by the description in the allocation decision step.

9. An information transmission medium for transmitting a compiler configured to make a computer convert a high-level language program into a machine language program and optimize a program, wherein
the program optimization includes:
a processing range decision step for deciding a part of the machine language program as a processing range to which the program optimization is applied based on a description included in the high-level language program; and
an allocation decision step for deicing an allocation position of an instruction code included in the processing range, wherein
the description is a description which specifies a correlative relation between a plurality of processing blocks contained in the high-level language program,
a part of the machine language program equivalent to the processing blocks between which the correlative relation is specified by the description is decided as the processing range in the processing range decision step, and
the allocation position of the instruction code included in the processing range is decided by each of the processing blocks based on the correlative relation specified by the description in the allocation decision step.
